(19) United States
(12) Patent Application Publication
(10) Pub. No.: US 2022/0307968 A1
(43) Pub. Date: Sep. 29, 2022

(54) LABORATORY APPARATUS FOR HYDROGEN PERMEATION ELECTROCHEMICALMEASUREMENTS UNDER HIGH PRESSURE, TEMPERATURE AND TENSILE STRESS

(71) Applicant: Saudi Arabian Oil Company, Dhahran (SA)

(72) Inventor: Yahya T. Al-Janabi, Dhahran (SA)

(21) Appl. No.: 17/210,287

(22) Filed: Mar. 23, 2021

(51) Int. Cl. G01N 17/00; G01N 15/08; G01N 27/49

(52) U.S. Cl. CPC G01N 17/006; G01N 15/08; G01N 27/49

(57) ABSTRACT

A system for performing electrochemical and hydrogen permeation measurements using a test specimen subject to tensile stress comprises a first housing filled with a process fluid supplied via an inlet with hydrogen sulfide, a second housing filled with a basic solution, a test specimen positioned between the first and second housings exposed to the process fluid on one side and to the basic solution on the other, first and second potentiostats coupled to the first and second housings to measure corrosion and induce hydrogen permeation, a loading device adapted to apply a longitudinal strain on the specimen, and a computing device configured to control operation of the potentiostat and loading device. The hydrogen sulfide in the process fluid impedes formation of diatomic hydrogen from atomic hydrogen, allowing adsorbed atomic hydrogen to enter into the steel test specimen from one side and permeate into the other side of the test specimen.

### FIELD OF THE DISCLOSURE

The present disclosure is in the field of electrochemistry and relates more particularly to an apparatus and method for the evaluation of materials, coatings, and corrosion inhibitors in which simultaneous electrochemical and atomic hydrogen permeation measurements are performed under high pressures and temperatures using a test specimen subjected to different forms of tensile stresses such as constant, slow strain, and cyclic loads.

### BACKGROUND OF THE DISCLOSURE

Natural gas and crude oil flow through thousands of miles of tubings, casings and pipelines (hereinafter referred to collectively as “conduits”) worldwide. Such conduits are typically made of mild steel. Due to the nature of the chemical environments to which the conduits are exposed, in particular, environments having hydrogen sulfide, the structures can be susceptible to two forms of corrosion attacks.

First, mild steel is susceptible to general corrosion. Corrosion involves two basic chemical processes—oxidation and reduction. With corrosion of mild steel, an oxidation reaction results in the deterioration of the metal matrix.

Fe^{o}→Fe⁺²+2e⁻[1]

In certain chemical environments, the concurrent reduction reaction results in the formation of atomic hydrogen.

H⁺+e⁻→H^{o} [2]

In most chemical environments, the atomic hydrogen produced in this reaction quickly undergoes a further reaction to form molecular hydrogen which passes harmlessly into the process environment.

2H^{o}→H₂(gas) [3]

Typically, the formation of molecular hydrogen occurs spontaneously with the reduction of hydrogen ion to atomic hydrogen. However, there are several chemical environments in which the formation molecular hydrogen is impeded, resulting in a higher concentration, or lifetime, of atomic hydrogen at or near the vicinity of the steel surface. One such environment, common to the gas and oil industry, is where H₂S is present in process fluids. These are termed sour environments. Dissolved H₂S dissociates fully in two steps into protons and sulfides as follows.

H₂S⇄H⁺+HS⁻ [4]

HS⁻⇄H⁺+S²⁻ [5]

The product sulfides in turn react with the iron of the conduit steel, generating a corrosion product film or layer containing iron sulfide (FeS), which can form locally or as a widespread layer. Atomic hydrogen is very soluble in the mild steel materials typically used to fabricate natural gas conduits and tends to diffuse into and permeate solid steel structures. When the atomic hydrogen permeates completely through the structure and thereafter combines to form molecular hydrogen, the molecular hydrogen disperses into the external environment and does not deleteriously affect the steel. In contrast, the atomic hydrogen that remains in the steel matrix migrates into microvoids in the structure. Combination to molecular hydrogen within the microvoids is problematic as the hydrogen molecules become trapped and exert internal pressure that, over time, can cause blistering or propagation of one or more cracks in the structure. Furthermore, the solubility of hydrogen atoms in the steel matrix increases with the amount of tensile stress on the structure. Altogether, the permeation of atomic hydrogen under conditions of tensile stress can cause hydrogen-induced damage (HID) that encompasses sulfide stress cracking (SSC), stress corrosion cracking (SCC), hydrogen-induced cracking (HIC) stepwise cracking, stress-oriented hydrogen-induced cracking (SOHIC), soft zone cracking and galvanically induced hydrogen stress cracking. Such cracking can eventually lead to a total failure of the pipe.

A measurement of the amount of hydrogen that enters into a steel matrix can be measured using a steel specimen that does not trap hydrogen atoms. Due to a concentration gradient, hydrogen atoms diffuse from the entry side of the steel specimen to the exit side. Hydrogen molecules are formed at the exit side of the specimen which can be measured by monitoring a pressure buildup. Alternatively, an electrochemical potential is applied to the exit side of the specimen forcing hydrogen atoms to instantaneously oxidize, i.e. the reverse of reaction of [2]. The hydrogen permeation rate can then be monitored by measuring the resulting electrons with time. In addition to hydrogen permeation rates, electrochemical methods can be used to measure corrosion.

The dominant damage mechanisms which pertain to carbon steels having yield strengths less than about 90,000 psi are different than in the case of higher strength steels having a yield strength above 90,000 psi. In the latter, the nature of the stress cracking and failure is different. Unlike the more gradual blistering and cracking which ultimately leads to fracture failure in the former class of steels, an instantaneous, catastrophic failure occurs in high strength steels. This is known as sulfide stress cracking (SSC).

In the related art, there are systems and apparatus that measure hydrogen permeation or corrosion including electrochemical cells. However, these systems are targeted to particular types of steels or parameters and lack the flexibility to measure hydrogen permeation and corrosion of different strength under high partial pressures of hydrogen sulfide, relatively high temperatures and different levels of tensile stress. Due to this relative lack of flexibility, the related art fails to distinguish the independent effects of the test parameters and how the impact of each parameter evolves over time.

### SUMMARY OF THE DISCLOSURE

In a first aspect, the present disclosure provides a system for performing electrochemical and hydrogen permeation measurements using a test specimen subject to different forms of tensile stress. The system comprises a first cell housing including a reservoir that forms a charging cell, the reservoir including a process fluid supplied via an inlet with hydrogen sulfide, a second cell housing including a reservoir that forms a permeation cell, the reservoir of the second cell including a basic solution, a test specimen having first and second sides and positioned between the first and second cell housings, the test specimen being exposed to the process fluid on the first side and to the basic solution on the second side while being electrically isolated from the first and second cell housings, first and second potentiostats coupled to the first and second cell housings respectively and adapted to apply a voltage potential to measure corrosion and hydrogen permeation through the specimen, a loading device coupled to and adapted to apply a longitudinal strain on the test specimen, and a computing device coupled to and configured to control operation of the potentiostat and loading device. The hydrogen sulfide present in the process fluid impedes formation of diatomic hydrogen from atomic hydrogen.

In a second aspect, the present disclosure provides a method of performing electrochemical and hydrogen permeation measurements using a test specimen subject to different forms of tensile stress. The method comprises arranging a test specimen between two reservoirs, a first side of the test specimen being exposed to a first reservoir containing a process fluid including hydrogen sulfide, and a second side of the test specimen being exposed to a second reservoir containing a basic solution, establishing a voltage potential at the first side of the test specimen, measuring a corrosion rate at the first side of the test specimen, establishing a voltage potential at the second side of the test specimen to generate an atomic hydrogen permeation transient for hydrogen atoms permeating from the first side to the second side of the specimen, and measuring the hydrogen permeation transient.

These and other aspects, features, and advantages can be appreciated from the following description of certain embodiments and the accompanying drawing FIGURES and claims.

### BRIEF DESCRIPTION OF THE DRAWINGS

FIG. 1 is a cross-sectional side view of an embodiment of a system for performing electrochemical and hydrogen permeation measurements using a test specimen subject to different forms of tensile stress according to the present disclosure.

### DETAILED DESCRIPTION OF CERTAIN EMBODIMENTS OF THE DISCLOSURE

The present disclosure describes a testing system that performs atomic hydrogen permeation and corrosion rate measurements through and on a test specimen under high pressures and relatively high temperatures. Tensile stresses can be simultaneously applied on a test specimen. The effects of each parameter can be monitored independently. The system includes a testing apparatus that comprises two identically-formed cells, a charging cell and a permeation cell, and a test specimen positioned between the cells. The charging and permeation cells enable hydrogen permeation tests according to the standard ISO 17081:2004(E). The charging cell and permeation cell are made of highly corrosion resistant material and are adapted to receive one test specimen at which both corrosion (general and localized) and hydrogen permeation measurements can be performed. The test specimen is sandwiched between the two cells, and is exposed, on one side, to the process environment in the charging cell at which hydrogen charging takes place. Hydrogen sulfide is introduced into the charging cell to initiate corrosion and to impede the formation of molecular hydrogen (reaction [3] above), allowing atomic hydrogen to enter into the test specimen. General and localized corrosion rate measurements can be performed on this side as well. The permeation cell on the other side of the test specimen is adapted to measure the atomic hydrogen which passes through the specimen.

The apparatus enables both corrosion and hydrogen permeation rate measurements. Corrosion rates can be measured using, for example, the linear polarization (LPR) method while localized corrosion rates can be measured using the electrochemical noise (ECN) method. The hydrogen permeation side contains a reservoir of sodium hydroxide. Hydrogen atoms which have permeated the test sample are oxidized to hydrogen ions by the electrochemical conditions present in this cell, i.e. the reverse of reaction [2]. The sodium hydroxide in the reservoir then neutralizes the hydrogen cations. The hydrogen permeation rate is determined from the current produced from the electrochemical oxidation of hydrogen. These measurements can take place while the specimen is placed under tensile strain. In some embodiments, holes are drilled in the test specimen for the attachment of grippers through which longitudinal tensile stresses are applied to the specimen.

Variables that can be studied using this apparatus include hydrogen sulfide partial pressure, process temperature, test solution chemistry, applied stress, test specimen metallurgy, coatings, and corrosion inhibitors and their impacts on general and localized corrosion and hydrogen permeation rates. The solutions in both compartments can be either stagnant or stirred. Corrosion rate and hydrogen permeation measurements are taken before and after varying these parameters to study their effects.

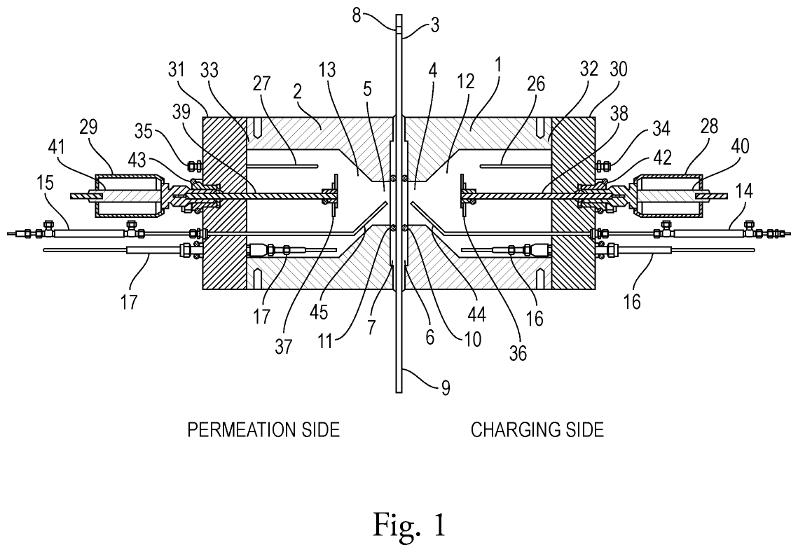

FIG. 1 is a cross-sectional view of an embodiment of an electrochemical hydrogen permeation measurement system according to the present disclosure. The system comprises two housings 1, 2, that are disposed adjacent to each other. The first cell housing 1, which comprises the charging cell, includes a reservoir filled with a process fluid 12 while the second cell housing, which comprises the permeation cell, includes a reservoir filled with a basic solution 13 such as a sodium hydroxide solution. The hydroxide solution can have a pH of at least 13. The cell housings 1, 2 are composed of highly corrosion-resistant material such as Hastelloy® C-276®.

The first cell housing 1 and the second cell housing 2 have both inner and outer ends. The inner end of the first cell housing 1 is positioned adjacent to the inner end of the second cell housing 2. The inner end of the first cell housing 1 is fitted with a portal having an opening 4. The inner end of the second cell housing 2 is fitted with a corresponding portal having an opening 5. A first lid 30 is positioned on the outer end of the first cell housing, and a second lid 31 is positioned on the outer end of the second cell housing. A test specimen 3 is positioned between the first cell housing 1 and the second cell housing 2 and is exposed to the fluids within the first and second cells via openings 4, 5. In some implementations, the process fluid 12 inside the charging cell corrodes the test specimen 3 and generates atomic hydrogen. Alternatively, hydrogen atoms can also be generated by applying a cathodic potential to the test specimen using the electrochemical arrangement. The sodium hydroxide solution inside the permeation cell neutralizes protons produced from oxidization of atomic hydrogen that permeates through the test specimen 3 from the charging side to the permeation side. The sodium hydroxide solution is deaerated using suitable inert gas before adding into the permeation side and immediately after to remove any air contamination which could occur during solution transfer. The material of the test specimen can be metallic or non-metallic, depending on the type of study being conducted. It can also be coated or non-coated. For hydrogen permeation studies, the test specimen 3 is preferably machined from low alloy steels such as carbon steels. When metallic test specimens are used, the test specimen acts as the working electrode in electrochemical measurements.

The test specimen 3 is electrically isolated from the first and second cell housings 1, 2 by respective insulating sheets 6, 7 that are positioned on either side of the specimen. The sheets 6, 7 can be made of electrically nonconducting Teflon®, for example. In addition to electrical insulation, the insulating sheets 6, 7 maintain gas tightness while tensile stress is applied to the test specimen. O-rings 10, 11 which can be composed of Ethylene Propylene Diene Monomer rubber (EPDM) are positioned between the insulating sheets 6, 7 and the cell housings 1, 2 within grooves machined into the housings. The O-rings 10, 11 maintain gas tightness between the two sheets and the housings. The test specimen is aligned vertically. Two holes 8 and 9 are drilled centrally on the top and bottom of the test specimen for gripping purposes. Grippers (not shown in FIG. 1) are connected to the top and bottom holes and can be used to apply tensile stresses using constant or variable loads.

Since the corrosion rate and the hydrogen permeation rate are affected by specimen surface characteristics, the specimens are machined to have a uniform finish. The charging side of the test specimen 3 is mechanically ground with SiC paper down to a 500 grade finish. The surface can be degreased with, for example, isopropyl alcohol or acetone, rinsed with deionized water, and dried prior to use. The side of the test specimen facing the base solution on the permeation side can be plated with elemental palladium (Pd). The following procedure can be followed for Pd plating. The permeation side of the test specimen is first polished using emery paper grade 1200, cleaned using acetone, cleaned briefly (3 s for an iron sample) using 18 M HCl acid, then immediately immersed in the plating solution. The plating solution is prepared using NH₄OH (28% wt) and PdCl₂ (5 g/l). The specimen is polarized using a cathodic current density of 2 mA/cm² for a duration of 90 s. Finally, the surface is then rinsed by distilled water and dried. This procedure should produce a continuous and adherent palladium film of approximately 0.1 μm thickness. This procedure can be conducted in-situ in the permeation cell. The coating insures that the surface of the test specimen exposed to the permeation cell is inert and will not oxidize during electrochemical procedures performed to measure the atomic hydrogen permeation rate. In addition, the use of a palladium coating provides a five-fold increase in the signal-to-background ratio over uncoated surfaces.

The charging cell (first cell housing) is adapted to receive an external reference electrode 14 and a counter electrode 16. The charging cell also includes a liquid inlet tube, a liquid outlet tube, a gas inlet tube, and a gas outlet tube 24 and associated valves. These elements are not shown in the FIG. 1 for ease of illustration. The pressure inside the cells is measured using a pressure gauge and a pressure transducer connected to the gas inlet line. The charging cell also includes a thermowell 26 and a stirrer 28. It is useful to position the reference electrode 14 close to the surface of the test specimen 3 using a salt bridge 44. The counter electrode 16 can be made of platinum which is inert to the chemical environments in the charging cell and in the permeation cell and is fitted to the lid 30 of the charging cell. The stirrer 28 consists of impeller 36, drive shaft 38, and magnetic drive 40 which can all be made of Hastelloy® C-276®. The magnetic drive 40 is secured into the lid 30 using a fitting nut and seal fitting 42. The magnetic drive can provide between 14 and 20 inch-pounds of torque and the rotational speed of the stirrer is adjustable according to the specific torque applied. The stirrer 28 promotes saturation of the charging side with gases, such as H₂S especially at high partial pressures since it takes significantly longer time to saturate the solution (to equilibrium) at high pressures relative to low pressures. The stirrer 28 also prevents concentration polarization of the charging solution in the vicinity of the test specimen 3.

Similarly, the permeation cell (the second cell housing 2) includes a reference electrode 15, a counter electrode 17, a liquid inlet tube, a liquid outlet tube, a gas inlet tube, a gas outlet tube and associated valves. The permeation cell further includes a thermowell 27, and a stirrer 29. The reference electrode 15 is positioned as close as practical to the surface of the test specimen 3 coated with palladium using a salt bridge 45. The counter electrode 17 is made of platinum which is inert to the chemical environments in the charging cell and in the permeation cell and is fitted to the lid 31 of the permeation cell. The stirrer 29 includes an impeller 37, drive shaft 39, and magnetic drive 41, which can all be made of Hastelloy® C-276®. The magnetic drive generates between 14 to 20 inch-pounds of torque and the rotational speed of the stirrer is adjustable according to the specific torque applied. On the permeation side, the stirrer helps deaerate the sodium hydroxide solution and replenish hydroxide ions at the vicinity of the test specimen as they are consumed in the neutralization reaction with protons.

The first and second cell housings 1, 2 are positioned adjacent to each other on a platform such as a metallic stand. The cell housings 1, 2 are positioned horizontally with an insulating material such as polyether ether ketone (PEEK) to electrically isolate the two cells from each other and from the stand. The test specimen 3 is pulled under a vertically tensile strain using a loading device (not shown in FIG. 1). The loading device can be used for any of: slow strain rate testing (SSRT), constant extension rate testing (CERT), and corrosion fatigue testing (CF). One such loading device that can be used in connection with the methods of the present disclosure is a frame system manufactured by Cortest, Inc. of Willoughby, Ohio.

The various strain and fatigue tests are used to rapidly evaluate alloy performance under simulated sour, i.e., containing H₂S, field conditions with hydrogen charging. The testing system includes a processor or computing unit and is supplied with a control and data acquisition software which includes a user interface that enables the investigator to set-up, run, monitor, and review tests. The testing system can be equipped with electrically isolated grip sets and Linear Variable Differential Transformers (LVDTs). The grip sets and transformers are implemented to provide for maximum sensitivity at low load levels up to a load capacity of 5,000 kg. For example, load measurement accuracy reaches +/−0.03% FS (Full Scale), and displacement measurement accuracy reaches +/−0.0015 mm FS. An extension rate ranges from 10 e⁻⁷ mm/s to 3.5 mm/s.

In operation, hydrogen atoms that permeate through the test specimen 3 are oxidized to hydrogen ions by the cell electrochemistry. The hydrogen ions react readily with the hydroxide ions present in the hydroxide reservoir in the permeation cell to form water. Neutralizing the hydrogen ions in this manner maintains the pH of the hydroxide solution in the hydroxide reservoir of the permeation cell 2. A change in pH would alter the solution chemistry thereby interfering with the hydrogen permeation measurements. Further, a pH of at least 13 prevents oxidation of the permeation test specimen 3. As mentioned previously, the palladium coating applied to the surface of the specimen 3 in communication with the hydroxide reservoir 1 also aids in preventing oxidation of this side of the specimen 3.

In the charging cell 1, the charging reference electrode 14, counter electrode 16 and test specimen 3 are connected by electrical conductors suitable for transmission of a signal to an electronic corrosion measurement device (not shown in FIG. 1). The corrosion measurement device is configured to apply a potential (e.g., using a potentiostat) to the respective electrodes 14, 16, and to measure, display and record resulting electrical corrosion data. Likewise, in the permeation cell 2, the permeation reference electrode 15, permeation counter electrode 17 and permeation test sample 3 are connected by electrical conductors suitable for transmission of a signal to an electronic hydrogen permeation measurement device (also not shown in FIG. 1). The hydrogen permeation measurement device is configured to apply a potential to the respective electrodes 15, 17 (e.g., using a potentiostat), and to measure, display and record resulting hydrogen permeation data. Devices suitable for performing such functions, such as potentiostats, are well known in the art. In some implementations, the potentiostats employed have a compliance voltage of ±15 V, a sweep range of ±3 V, current output of ±500 mA with connections to a serial port of a loading device computer. It is noted that the values are approximate and that different parameter values can be used.

In terms of operation, in the charging cell 1, the potentiostat is used to measure the corrosion rate or to apply a cathodic potential. For example, the well-known polarization resistance method can be used for measuring the corrosion rate. In this method, the potentiostat sequentially applies different voltage potentials to the counter electrode 16 to achieve several desired potentials at the working electrode, i.e., test specimen 3. For example, potentials of +0.010, 0.0 and −0.010 volts vs. ground are established at test specimen 3. The current flowing between the corrosion counter electrode 16 and the test specimen 3 is measured at each of these potentials. A corrosion rate may then be calculated using a well-known algorithm. The corrosion reference electrode 14 functions as a feedback element to ensure that the desired potential is applied to the test specimen 3.

The charging counter electrode 16 can be used to apply a charging current to the test specimen 3. In some implementations, the charging current ranges between 50 and 150 milliamps per cm² of exposed test specimen surface area. However, this current is not required to obtain the hydrogen permeation rate and general corrosion rate of a specimen. In certain cases, however, application of the charging current may simulate the longer exposure times to corrosive environments experienced in the field thus improving the applicability of the test cell data. Moreover, it can be used for example to simulate field conditions arising from exposing the external surfaces of buried pipelines to cathodic protection. All electrodes are electrically coupled to the testing system including the potentiostats that are controlled electronically.

In the permeation cell 2, the potentiostat applies a voltage potential to the permeation counter electrode 17 so that a desired potential is applied at the test specimen 3, which is the working electrode. For example, the potentiostat can be used to charge the test specimen with hydrogen atoms by applying a constant potential of −1050 mV versus Ag/AgCl reference electrode from the charging side. The anodic side of the specimen on the permeation side is kept at a constant potential of +350 mV vs. Ag/AgCl for hydrogen permeation. After each permeation transient had been recorded, the specimen is discharged by setting the potential to +300 mV Ag/AgCl on both sides, removing the diffusible hydrogen atom from the metal. Current and potential in both cells are constantly logged during the experiments. Experiments can be carried out at different temperatures and pressures. Oxidation of the atomic hydrogen which has passed through the test specimen 3 produces a current, the hydrogen permeation current, which is measured by the potentiostat and recorded by testing system.

When the background permeation current of the test specimen is stable, e.g., at less than about 1 microamp per square centimeter (μA/cm²), the charging cell is pressurized with hydrogen sulfide gas mixture to the required level. The atomic hydrogen permeation rate and corrosion rate measurements are obtained and recorded. Thereafter, any of the following cell parameters can be varied: gas pressure, solution temperature, solution chemistry, stirring rate, and/or tensile stresses. The atomic hydrogen permeation rate and corrosion rate measurements are obtained and recorded throughout. Comparable data for any number of different variables can be obtained in this manner. Data acquisition and analysis are computerized and automated through the use of a suitable commercial software and general-purpose computer.

To establish the desired pressure and chemical conditions, different partial pressures of carbon dioxide (CO₂) and H₂S are used. Oxygen gas can be injected as well. These partial pressures could be topped by nitrogen gas or hydrocarbon gas, such as natural gas including methane, CH₄, ethane, C₂H₆ . . . etc. The test solution could be a mixture of liquid hydrocarbons and an aqueous part which in turn could contain salts and oilfield chemicals like corrosion and scale inhibitors, biocides, oxygen scavengers . . . etc. The chemical composition of the test environment (pH, dissolved H₂S, dissolved iron . . . ) is monitored to ensure suitable control of test conditions. Electrochemical characterization of surface reactions under pressure can also be used, as well as post-test surface analysis.

The apparatus described herein enables hydrogen permeation tests according to ISO 17081:2004(E) at elevated temperature and pressure. ISO is the International Organization for Standardization and ISO 17081:2004(E) specifies a laboratory “Method of measurement of hydrogen permeation and determination of hydrogen uptake and transport in metals by an electrochemical technique”. Additionally, it is possible to apply load on the test specimen separating the testing cells. The loading device can comprise a computer-controlled and electromechanically operated loading device unit that can be operated as a SSRT, a constant load and optionally as a low cycle fatigue unit. The computer controls a step motor and gear box that are used to load the specimen. The loading parameters are configured using program instruction executed on the computer. The load measurement values are displayed in the computer software. Displacement and load data are recorded. When a constant load is applied, the load response is used as a feedback signal to the computer software that controls the motor. In other words, the computer controls the displacement in such a way that the load cell measurement value is equal to the load set point specified by the operator. The loading device is also capable of performing low frequency cyclic fatigue tests. The cyclic loading is performed either under load or strain control. The shape of the loading is either trapezoidal (a special case: saw tooth) or sinusoidal type. The maximum frequency depends on the amplitude but a reasonable fₘₐₓ is about 0.02 Hz.

Potentiostats are used for both potential measurements and for potential control. The potentiostats are controlled using a software capable of performing simple operations including corrosion potential measurements, potentiostatic measurements, galvanostatic measurements, cyclic sweeps, electrochemical impedance spectroscopy measurements, and electrochemical noise. The potentiostat control software is integrated within the loading device software and are operated by the loading device computer. The potentiostat output signals (potential and current) are saved in the same file where the loading device data reside. In certain implementations, the potentiostats employed have a compliance voltage of ±15 V, a sweep range of ±3 V, current output of ±500 mA with connections to a serial port of a loading device computer.

The following describes steps of a corrosion and hydrogen permeation measurement test procedure based on the ISO 17081:2004(E) standard. In a first step, the surface of the test specimen is polished to a desired surface finish. In a following step the solutions of the charging and permeation cells are prepared. The accuracy of the reference electrodes is then verified. After these preliminary steps the apparatus comprising the two cells and test specimen is constructed. The solution for the permeation cell is added to the second cell housing. The solution is purged with nitrogen gas for two hours to remove any trace of air from the cell. The electrical potential is then set to the control value. In the electrochemical arrangement, the charging side of the test specimen can be allowed to corrode freely or can be charged cathodically, while the permeation side is polarized anodically to oxidize the permeating hydrogen atoms and measure the permeation current. The arrangement is also configured so that electrochemical measurements such as linear polarization, Tafel scans, electrochemical impedance spectroscopy, electrochemical noise, etc. can be performed.

Once an oxidation current has achieved a steady value, the process solution is added to the charging cell. In some cases, an aqueous solution may be added to the charging cell prior to establishment of the steady-state oxidation current provided that exposure does not generate significant hydrogen, e.g. a passivating system with a very low passive current. When testing at an elevated temperature, the thermal shock can be minimized by slowly adding the preheated solution to the charging side, as this can sometimes result in significant perturbation of the passive current in the permeation cell. The charging solution is de-aerated by purging with nitrogen gas to remove oxygen quickly. At this point, the stirring motors are switched on. For non-passivating systems, galvanostatic charging or potentiostatic charging on exposure of the test sample commences. In a following step, the process solution in the charging cell is heated to a targeted temperature (<90° C.). Any increase in pressure due to water vapor is observed. Once the target temperature is reached, hydrogen sulfide (and other test gases) are supplied and the pressure in the charging cell is recorded for each gas introduced, with care being taken to maintain an equal gas pressure on both sides of the test specimen. The pressure on the permeation cell is maintained using pure nitrogen gas. Once a targeted pressure is obtained, a constant or variable tensile stress is applied to the test specimen. The total oxidation current (comprising background passive current and atomic hydrogen oxidation current) is monitored until steady state is achieved. For tests in which corrosion inhibitors are evaluated, a targeted amount of inhibitors are injected into the first cell housing containing the charging solution. Samples of the charging process solution are then drawn and analyzed for pH, iron count and residual corrosion inhibitor analysis. If significant corrosion has occurred, the final thickness and weight of the specimen is measured.

Any test performed can be repeated to determine the repeatability of the method of measurement. Once an experiment is completed, the apparatus is allowed to cool down, the H₂S gas is released to a scrubber and any remaining gas is purged by applying a positive pressure using nitrogen gas.

The testing system described above has the advantage that it enables a number of distinct tests to be conducted. The system enables hydrogen permeation (HP) measurements in which atomic hydrogen is generated either by electrochemical reactions taking place in the test environment or by imposing an electrochemical potential. HP experiments can be conducted: at variable H₂S and CO₂ partial pressures; at variable temperatures; with no stress, constant stress or variable tensile stress applied; and with stagnant or stirred test solutions; on coated or uncoated test specimens; on test specimens constructed from a range of metallic and non-metallic materials. Hydrogen permeation measurements can be obtained in the presence of oilfield chemicals like corrosion and scale inhibitors and biocides. This range of experimental combinations allows the full range of field conditions to be tested.

### EXAMPLE

In one experimental arrangement, the first and second cell housings 1, 2 are cylindrical in form, with an overall height of 6.21 in., external diameter of 5.50 in., internal diameter of 3.50 in., depth of 3.03 in., and a volume capacity of 0.5 liters. To control temperature inside the cell, a heating and cooling jacket surrounds the body of the cell (not shown in FIG. 1). The jacket can be made of aluminum 6061 and can be coupled to a heating and cooling bath (also not shown). Fluid can be circulated through the jacket between the bath and the jacket for temperature control to maintain an operating temperature in a range of the system of −20° F. to +194° F. (−29° C. to +90° C.). The operating pressure at the high end of the temperature range is 2,000 psig (14 MPa). In the experimental arrangement, the insulating sheets 6, 7 are 5.50 in. in diameter and 7/32 in. in thickness. The test specimen 3 is 10 inches long, 1.750 inches wide, and 0.079 inches thickness. The test specimen is positioned vertically. Two holes 8 and 9 are drilled centrally on the top and bottom of the test specimen for gripping purposes.

The salt bridge 44 can be made of a ¼ in. Hastelloy® C-276® tube, filled with saturated KCl solution, and fitted at the end with a Teflon capillary tube and a frit. The reference electrode can be Ag/AgCl, rated for 5000 psi and 300° C. with all wetted surfaces made of Hastelloy® C-276®. The reference electrode is fitted into the lid 30 of the first cell housing 1 using a′/4 in. NPT, while the diameter of the tube inside the cell is 0.25 in. The reference electrode 14 is positioned as close as practical to the surface of the test specimen 3 using the salt bridge 44. The counter electrode is fitted into the lid 30 using ¼ in. male connector fitting made of Hastelloy® C-276®. The liquid inlet tube and the liquid outlet tube are ¼ in. (outside diameter) and connected to the lid 30 using a male connector fitting 34. The gas inlet tube and the gas outlet tube are ⅛ in. outside diameter OD and connected to the lid using a gland nut fitting. The thermowell 26 is ¼ in. diameter 0.035 in. wall thickness, 5 in. long and connected to the lid 30 using a male connector fitting 34.

Similarly, in the permeation cell, reference electrode 15 is positioned as close as practical to the surface of the test specimen 3 coated with palladium using a salt bridge 45. The salt bridge is made of a′/4 in. Hastelloy® C-276® tube, filled with saturated KCl solution, and fitted at the end with a Teflon capillary tube and a frit. The reference electrode is Ag/AgCl, rated for 5000 psi and 300° C., and all wetted surfaces are made of Hastelloy® C-276®.

The counter electrode is fitted into the lid 31 of the vessel using ¼ in. male connector fitting made of Hastelloy® C-276®. The liquid inlet tube 19 and the liquid outlet tube 21 are ¼ in. OD connected to the lid using a male connector fitting which is ¼ in. OD tube, ¼ in. NPT male and all are made of Hastelloy® C-276® (not shown in the drawing). The gas inlet tube 23 and the gas outlet tube 25 are ⅛ in. OD made of Hastelloy® C-276® connected to the lid using a gland nut fitting which is ¼ in. OD tube made of 316 SS (not shown in the drawing). The thermowell 27 is ¼ in. diameter 0.035 in. wall thickness, 5 in. long, connected to the lid using a male connector fitting 35 and all are made of Hastelloy® C-276®. The stirrer 29 consists of impeller 37, drive shaft 39, and magnetic drive 41, all made of Hastelloy® C-276®. The magnetic drive 41 is secured into the lid 31 using 316 SS fitting nut and C-276 olive seal fitting 43. The magnetic drive is 16 in-lbs. torque and is manufactured by Parr, USA. On the permeation side, the stirrer helps replenish hydroxide ions at the vicinity of the test specimen as they are consumed in the neutralization reaction with protons. The lid 31 is 5.5 in. in diameter, 1.375 in. thick and made of Hastelloy® C-276®. The lid 31 is tightened into the body of the cell using M10 screws which are 50 mm long, 1.5 mm pitch, socket head cap, made of black-oxide alloy steel. The seal between the lid and the body of the cell is achieved using a PTFE (polytetrafluoroethylene) O-ring 33.

In operation, the cell body is filled with process solution, typically a high salinity brine. Suitable solutions include NACE TM-0177 and NACE TM-0284. The TM-0177 solution is 94.5 percent by weight deionized or distilled water, 0.5 percent glacial acetic acid and 5.0 percent sodium chloride. The TM-0284 solution is prepared in accordance with ASTM STANDARD SPECIFICATION D 1141, stock solutions 1 and 2, without heavy metal ions. The stirrer 28 is activated and maintained at a stir rate of approximately 300 to 400 rpm. Cell temperature is monitored and maintained at the pre-set temperature of −20° F. to +194° F. (−29° C. to +90° C.). A heating/cooling jacket is used to maintain the required cell temperature. The head spaces remaining in both sides of the cell are purged with nitrogen gas and sealed to eliminate oxygen. The hydroxide reservoir is filled with 0.1N sodium or potassium hydroxide solution.

The strain loading device can be implemented using a gear box unit having the following specifications: a maximum load of 30 kN; a maximum displacement of 3 cm.; a load measuring amplifier with accuracy of 0.04% of full scale and resolution of 1 N; a load stability of at most ±0.5% FS in stable operation conditions (stable room temperature, no fast temperature transients); a step motor with a movement indicator. The loading device is capable of loading the specimen with 1000 MPa yield stress. The displacement rate is designed to range from 2.5E-7 mm/s to 3.8E-2 mm/s.

It is to be understood that any structural and functional details disclosed herein are not to be interpreted as limiting the systems and methods, but rather are provided as a representative embodiment and/or arrangement for teaching one skilled in the art one or more ways to implement the methods.

It is to be further understood that like numerals in the drawings represent like elements through the several FIGURES, and that not all components or steps described and illustrated with reference to the figures are required for all embodiments or arrangements.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and “comprising”, when used in this specification, specify the presence of stated features, integers, steps, operations, elements, or components, but do not preclude the presence or addition of one or more other features, integers, steps, operations, elements, components, or groups thereof.

Terms of orientation are used herein merely for purposes of convention and referencing and are not to be construed as limiting. However, it is recognized these terms could be used with reference to a viewer. Accordingly, no limitations are implied or to be inferred.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A system for performing electrochemical and hydrogen permeation measurements using a test specimen subject to different forms of tensile stress, comprising:
a first cell housing including a reservoir that forms a charging cell, the reservoir including a process fluid supplied via an inlet with hydrogen sulfide;
a second cell housing including a reservoir that forms a permeation cell, the reservoir of the second cell including a basic solution;
a test specimen having first and second sides and positioned between the first and second cell housings, the test specimen being exposed to the process fluid on the first side and to the basic solution on the second side while being electrically isolated from the first and second cell housings;
first and second potentiostats coupled to the first and second cell housings respectively and adapted to apply a voltage potential to measure corrosion and hydrogen permeation through the specimen;
a loading device coupled to and adapted to apply a longitudinal strain on the test specimen; and
a computing device coupled to and configured to control operation of the potentiostat and loading device,
wherein the hydrogen sulfide present in the process fluid impedes formation of diatomic hydrogen from atomic hydrogen.

2. The system of claim 1, further comprising a heating and cooling jacket coupled to the computing device, wherein the computing device is configured to control the heating and cooling jacket to maintain a temperature of the first and second cell housing in a range of 20° F. to an elevated temperature of +194° F. (−29° C. to +90° C.).

3. The system of claim 1, wherein the first and second cell housings including gas inlets, and the computing device is configured to control a gas supply through the gas inlets to maintain a pressure within the reservoirs of the first and second cell housings in a range of 1 MPa to an elevated pressure of 14 MPa.

4. The system of claim 1, wherein the first side of the test specimen is provided with a smooth finish and the second side of the test specimen is coated with palladium.

5. The system of claim 1, further comprising a first stirrer positioned in the first cell housing adapted to promote saturation of the charging cell with H₂S gas at high partial pressures reaching up to 2 MPa.

6. The system of claim 5, further comprising a second stirrer positioned in the second cell housing adapted to promote replenishment of hydroxide ions in the vicinity of the test specimen.

7. The system of claim 1, wherein the first cell housing includes a first reference electrode and a first counter electrode that are coupled to the first potentiostat, wherein the first potentiostat is adapted to apply a voltage potential to the first counter electrode to achieve a desired potential on the first side of test specimen, and wherein the voltage between the counter electrode and the test specimen causes a current to flow between the counter electrode and the test specimen, measured by the potentiostat, from which a corrosion rate is determined.

9. The system of claim 1, wherein the second housing cell includes a second reference electrode and a second counter electrode that are coupled to the second potentiostat, wherein the second potentiostat is adapted to apply a voltage to second counter electrode to generate a negative potential at the second side of the test specimen sufficient to oxidize atomic hydrogen that permeates the test specimen into the basic solution in the second cell housing for hydrogen permeation transient measurements.

10. The system of claim 1, wherein the loading device is adapted to provide one of a constant strain load and variable strain load based upon signals received from the computing device.

11. A method of performing electrochemical and hydrogen permeation measurements using a test specimen subject to different forms of tensile stress, comprising:
arranging a test specimen between two reservoirs, a first side of the test specimen being exposed to a first reservoir containing a process fluid including hydrogen sulfide, and a second side of the test specimen being exposed to a second reservoir containing a basic solution;
establishing a voltage potential at the first side of the test specimen;
measuring a corrosion rate at the first side of the test specimen;
establishing a voltage potential at the second side of the test specimen to generate an atomic hydrogen permeation transient for hydrogen atoms permeating from the first side to the second side of the specimen; and
measuring the hydrogen permeation transient.

12. The method of claim 11, further comprising applying a longitudinal strain to the test specimen.

13. The method of claim 12, wherein the longitudinal strain is constant in force.

14. The method of claim 12, wherein the longitudinal strain is variable in force.

15. The method of claim 11, further comprising stirring the process fluid in the first reservoir and the basic solution in the second reservoir.

16. The method of claim 11, further comprising controllably maintaining a pressure in the first and second reservoirs at a selected magnitude in a range of 1 MPa to an elevated pressure of 14 MPa.

17. The method of claim 11, further comprising controllably maintaining a temperature in the first and second reservoirs at a selected magnitude in a range of 20° F. to an elevated temperature of +194° F. (−29° C. to +90° C.).
